(19) United States
(12) Patent Application Publication
(10) Pub. No.: US 2016/0127232 A1
(43) Pub. Date: May 5, 2016

(54) MANAGEMENT SERVER AND METHOD OF CONTROLLING PACKET TRANSFER

(71) Applicant: FUJITSU LIMITED, Kawasaki-shi (JP)

(72) Inventor: Shinya KANO, lnagi (JP)

(21) Appl. No.: 14/868,173

(22) Filed: Sep. 28, 2015

(30) Foreign Application Priority Data
Oct. 31, 2014 (JP) 2014-223040

(51) Int. Cl. H04L 12/741; H04L 29/06

(52) U.S. Cl. CPC H04L 45/74; H04L 69/22

(57) ABSTRACT

A computer detects a key server located on a path through which a packet transmitted from a terminal is transferred. The key server is one of network servers located on the path. The key server satisfies a predetermined condition. Each of the network servers is configured to receive the packet and change a destination address set in the packet. The computer detects the key server located on a first path. The computer detects the key server located on a second path upon the first path being modified to obtain the second path. The computer assigns, if the key server located on the second path is different from the key server located on the first path, a first address to the key server located on the second path. The first address has been assigned to the key server located on the first path.

### CROSS-REFERENCE TO RELATED APPLICATION

This application is based upon and claims the benefit of priority of the prior Japanese Patent Application No. 2014-223040, filed on Oct. 31, 2014, the entire contents of which are incorporated herein by reference.

### FIELD

The embodiment discussed herein is related to a management server and a method of controlling packet transfer.

### BACKGROUND

When a terminal located at a certain location accesses an external site (server terminal) or accesses a terminal located at another location, communication is executed through network servers (NW servers) that are configured to execute various processes such as a firewall and a web proxy. In the communication, internet protocol (IP) addresses are assigned to the NW servers installed in a network, and a path is set in relay devices installed in the network so as to ensure that a packet is transferred to the NW servers. The path is set by a network management server or a person, or autonomously set by a routing protocol implemented in a router. A path in which a packet is transferred from a certain location to another location through one or more NW servers configured to execute predetermined processes on the packet is referred to as a service chain.

The NW servers may be mainly classified into NW servers (referred to as “first-class NW servers”) of a first group and NW servers (referred to as “second-class NW servers”) of a second group. The first-class NW servers each execute a relay process without changing header information of the packet received and to be transferred. The first-class NW servers include an NW server having a firewall function and an NW server having a deep packet inspection (DPI) function.

The second-class NW servers each receive a packet having a destination address and transfer the packet whose destination address has been converted to another address due to certain processing. The second-class NW servers include a web proxy that terminates a transmission control protocol (TCP) session and transfers a packet to a next TCP session. The second-class NW servers also include an NW server, such as a network address translation (NAT), which converts a specific destination address to another address. In order to execute communication through a second-class NW server, the transmitting terminal adds, to a packet, a specific destination address causing the packet to be directed to the second-class NW server and transmits the packet.

Related techniques are disclosed in, for example, Japanese National Publication of International Patent Application No. 2014-511086 and Japanese National Publication of International Patent Application No. 2013-509082.

Together with a change in a requirement for communication, a second-class NW server that has an address to be set as a destination address of a packet by a transmitting terminal may be removed from an existing service chain. In another case, another second-class server may be added at a position closer to a transmitting terminal than a second-class NW server that has an address to be set as a destination address of a packet by the transmitting terminal. In these cases, it is cumbersome to request the terminal to change the destination address of the packet.

### SUMMARY

According to an aspect of the present invention, provided is a method of controlling packet transfer in which a computer detects a key server located on a path through which a packet transmitted from a terminal is transferred. The key server is one of network servers located on the path. The key server satisfies a predetermined condition. Each of the network servers is configured to receive the packet and change a destination address set in the packet. The computer detects the key server located on a first path. The computer detects the key server located on a second path upon the first path being modified to obtain the second path. The computer assigns, if the key server located on the second path is different from the key server located on the first path, a first address to the key server located on the second path. The first address has been assigned to the key server located on the first path.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an exemplary configuration of a network system according to an embodiment;

FIG. 2 is a diagram illustrating service chains within the network system illustrated in FIG. 1;

FIG. 3 is a diagram illustrating an exemplary configuration of a management server;

FIG. 4 is a diagram illustrating an exemplary data structure of a database storing information on a configuration of a service chain;

FIG. 5 is a diagram illustrating an exemplary hardware configuration of an information processing device (computer) that operates as a management server;

FIG. 6 is a flowchart illustrating, as a first operation example, an example of operations when a management server receives a request to remove an NW server from a service chain;

FIG. 7A is a diagram illustrating a first specific example of the first operation example of a management server;

FIG. 7B is a diagram illustrating a first specific example of the first operation example of a management server;

FIG. 8A is a diagram illustrating a second specific example of the first operation example of a management server;

FIG. 8B is a diagram illustrating a second specific example of the first operation example of a management server;

FIG. 9 is a flowchart illustrating, as a second operation example, an example of operations when a management server receives a request to add an NW server to a service chain;

FIG. 10A is a diagram illustrating a first specific example of the second operation example of a management server;

FIG. 10B is a diagram illustrating a first specific example of the second operation example of a management server;

FIG. 11 is a diagram illustrating a second specific example of the second operation example of a management server;

FIG. 12 is a flowchart illustrating, as a third operation example, an example of operations when a management server receives a request to remove an NW server (second-class NW server) from a service chain including a branch;

FIG. 13A is a diagram illustrating a specific example of the third operation example of a management server;

FIG. 13B is a diagram illustrating a specific example of the third operation example of a management server;

FIG. 14 is a diagram illustrating an example of a service chain built using NFV; and

FIG. 15 is a diagram illustrating an exemplary configuration of a network system according to an embodiment.

### DESCRIPTION OF EMBODIMENT

Hereinafter, an embodiment is described with reference to the accompanying drawings. A configuration described in the embodiment is an example, and techniques disclosed herein are not limited to the configuration described in the embodiment.

Network Configuration

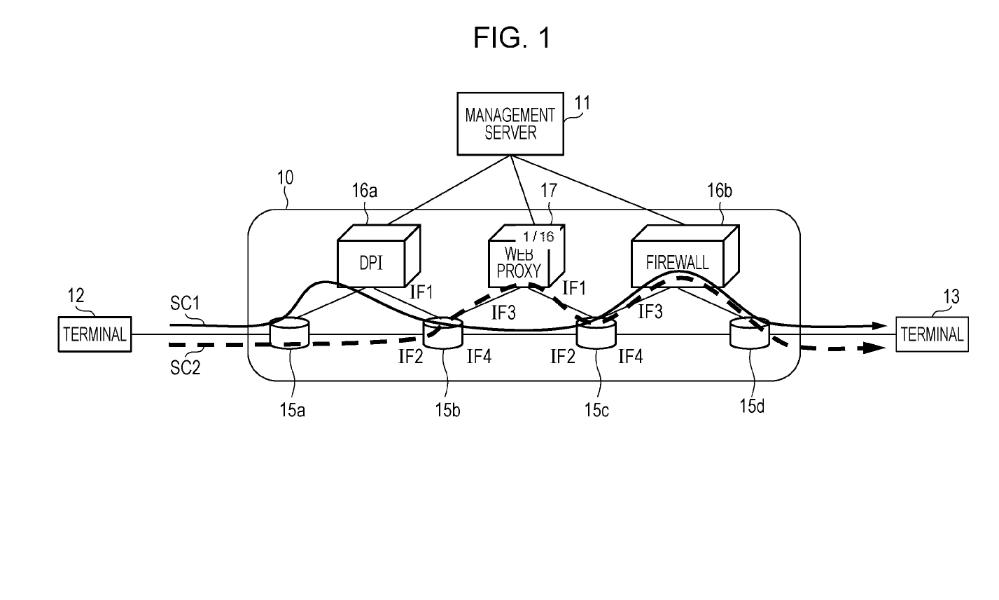

FIG. 1 is a diagram illustrating an exemplary configuration of a network system according to the embodiment. In FIG. 1, the network system includes a network 10, a management server 11, a terminal 12, and a terminal 13.

The terminal 12 is located at a certain location, while the terminal 13 is located at another location. The terminal 12 operates as a transmitting terminal that transmits a packet to the terminal 13. The terminal 13 operates as a receiving terminal that receives the packet from the terminal 12. Each of the terminals 12 and 13 is one selected from among a personal computer (PC), a workstation (WS), a server machine, a tablet terminal, a personal digital assistant (PDA), a smartphone, a feature phone, and the like. A link that connects the terminal 12, the terminal 13, and the network 10 to each other may be a wired link or a link including a wireless section.

The network 10 includes one or more relay devices 15 configured to relay a packet transmitted by the terminal 12. In the example illustrated in FIG. 1, relay devices 15a, 15b, 15c, and 15d are illustrated. The network 10 also includes one or more network servers (NW servers) configured to execute predetermined processes on the packet transmitted by the terminal 12. In the example illustrated in FIG. 1, NW servers 16 and an NW server 17 are illustrated. The relay devices 15 are, for example, routers or Layer-3 switches (L3 switches).

The NW servers 16 are first-class NW servers configured to execute a relay process without changing header information of the packet received and to be transferred. In the example illustrated in FIG. 1, an NW server 16a having a DPI function and an NW server 16b having a firewall function are illustrated. The DPI function is a function of analyzing information of a data part (payload) of an IP packet in order to determine a processing method such as filtering. The NW server 16a may filter a packet having predetermined data.

The NW server 17 is a second-class NW server configured to receive a packet having a destination address and transfer the packet whose destination address has been converted to another address due to certain processing. In the example illustrated in FIG. 1, the NW server 17 has a web proxy function of terminating a TCP session and transferring a packet to a next TCP session. Second-class NW servers include an NW server having an NAT function and an NW server having a web cache function.

The management server 11 may control the network 10 including the NW servers 16 and the NW server 17 and control a transfer path of a packet transmitted by the terminal 12. The management server 11 may control the transfer path of the packet transmitted by the terminal 12, thereby cause the packet to pass through one or more NW servers, and provide a desired service to the packet. A path in which a packet passes through one or more NW servers is referred to as a service chain.

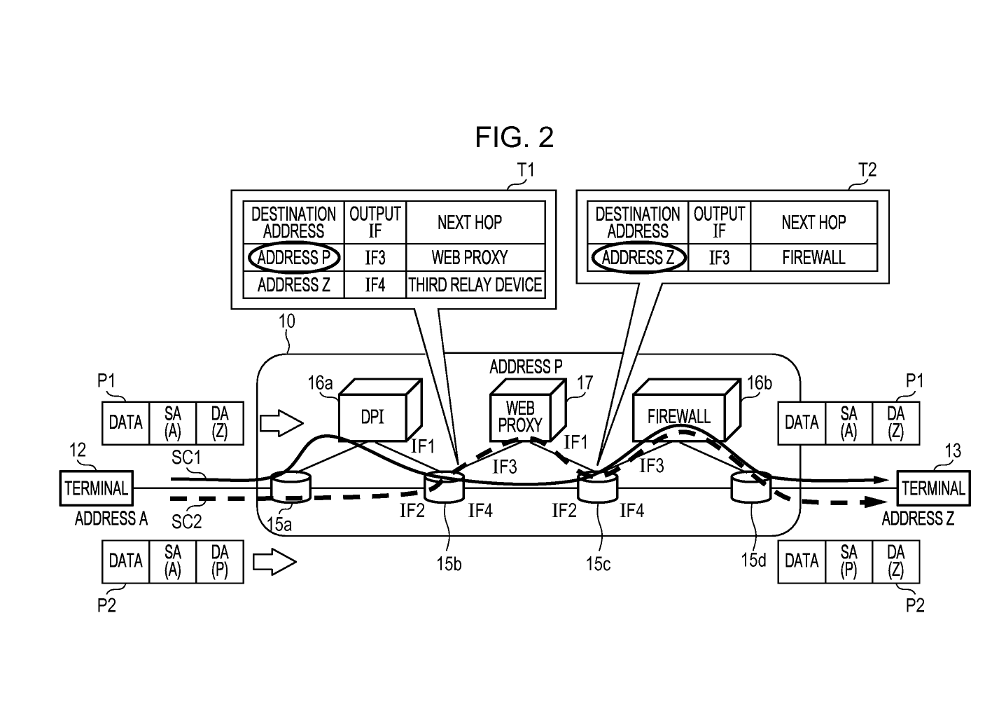

In FIG. 1, as an example of service chains for a packet transmitted by the terminal 12, a service chain SC1 and a service chain SC2 are illustrated. FIG. 2 is a diagram illustrating the service chain SC1 and the service chain SC2. The service chain SC1 is a path through which a packet reaches the terminal 13 after passing through the NW server 16a and the NW server 16b. The service chain SC2 is a path through which a packet reaches the terminal 13 after passing through the NW server 17 and the NW server 16b.

Referring to FIG. 2, the terminal 12 has an address “A” and the terminal 13 has an address “Z”. The NW server 17 has an address “P”. When the service chain SC1 is used, the terminal 12 transmits a packet P1 having the address “A” set as a source address (SA) and the address “Z” (address of the terminal 13) set as a destination address (DA).

In the network 10, the packet P1 is transferred by the relay device 15a to the NW server 16a. After executing a process related to DPI for the packet P1, the NW server 16a transfers the packet P1 to the relay device 15b. The relay device 15b transfers the packet P1 to the relay device 15c. The relay device 15c transfers the packet P1 to the NW server 16b. After executing a process related to a firewall for the packet P1, the NW server 16b transfers the packet P1 to the relay device 15d. The relay device 15d transfers the packet P1 to the terminal 13. The terminal 13 receives the packet P1. In this manner, in the service chain SC1, the destination address (DA) of the packet P1 is not changed by the NW servers 16a and 16b.

When the service chain SC2 is used, the terminal 12 transmits a packet P2 having the address “A” set as a source address (SA) and the address “P” (address of the NW server 17) set as a destination address (DA).

Upon receiving the packet P2, the relay device 15a transfers the packet P2 to the relay device 15b. The relay device 15b transfers the packet P2 to the NW server 17 in accordance with details registered in a path information table (routing table) T1 included in the relay device 15b. The NW server 17 (web proxy) terminates a TCP session set between the terminal 12 and the NW server 17 and transfers the packet P2 to another TCP session set between the NW server 17 and the terminal 13. At this time, the NW server 17 changes (alters) the destination address “P” of the packet P2 to the address “Z” of the terminal 13 and transfers the packet P2 to the relay device 15c.

The relay device 15c transfers the packet P2 to the NW server 16b in accordance with details registered in a routing table T2 included in the relay device 15c. After executing a process related to the firewall for the packet P2, the NW server 16b transfers the packet P2 to the relay device 15d. The relay device 15d transfers the packet P2 to the terminal 13, and the terminal 13 receives the packet P2.

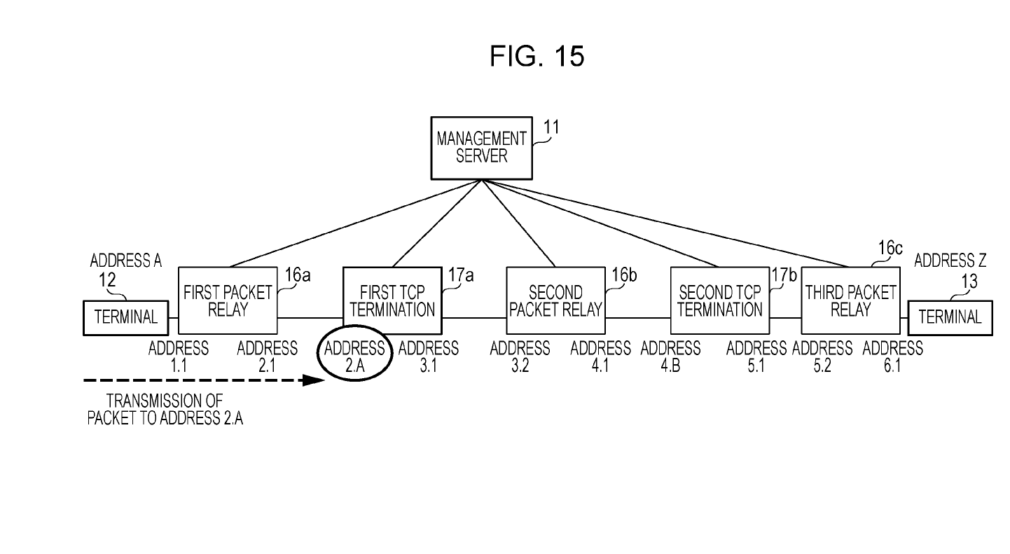

A network system illustrated in FIG. 15 is assumed. In FIG. 15, illustration of the relay devices 15 is omitted, and NW servers 16 and 17 that are installed on a service chain (path of a packet) between the terminals 12 and 13 are illustrated.

As illustrated in FIG. 15, the service chain includes three NW servers, the NW server 16a (first packet relay), the NW server 16b (second packet relay), and an NW server 16c (third packet relay) as NW servers 16 (first-class NW servers) that do not change a destination of a packet to be transferred.

The service chain also includes two NW servers, an NW server 17a (first TCP termination) and an NW server 17b (second TCP termination) as NW servers 17 (second-class NW servers) that change a destination of a packet to be transferred. A packet transmitted by the terminal 12 (transmitting terminal) passes through the NW servers in order of the NW server 16a, the NW server 17a, the NW server 16b, the NW server 17b, and the NW server 16c. After that, the packet is received by the terminal 13 that is the destination of the packet.

In the service chain illustrated in FIG. 15, the terminal 12 that serves as the transmitting terminal transmits a packet having the address “A” set as an SA and an address “2.A” set as a DA. The packet is relayed by the NW server 16a and received by the NW server 17a. The NW server 17a terminates a TCP session and transfers the packet to a next TCP session. At this time, the NW server 17a changes the DA of the packet to an address “4.B” of the NW server 17b. The packet is relayed by the NW server 16b and received by the NW server 17b. The NW server 17b terminates the TCP session and transfers the packet to a next TCP session. At this time, the NW server 17b changes the DA of the packet to the address “Z” of the terminal 13. The terminal 13 receives the packet relayed by the NW server 16c.

It is assumed that the NW server 17a is removed from the network system described above. In this case, it is considered that a request to set the address “4.B” of the NW server 17b as the destination address of a packet to be transferred in the service chain is provided to the terminal 12. However, when multiple terminals other than the terminal 12 use the service chain, the destination address is to be changed in each of the multiple terminals, and operations are cumbersome.

Another second-class NW server may be added and located on the upstream side of the NW server 17 in the service chain SC2 illustrated in FIG. 2. Another second-class NW server may be added and located on the upstream side of the NW server 17a in the service chain illustrated in FIG. 15. In each of these cases, it is considered that a destination address of a packet transmitted by the terminal 12 to the service chain is changed to ensure that the packet transmitted by the terminal 12 is received by the corresponding second-class NW server. An operation of changing the destination address, however, may be cumbersome, like an operation of changing the destination address upon the removal of the aforementioned NW server 17.

The embodiment describes a method of selecting a path by the management server so as to avoid a change in a destination address, set by the terminal 12, of a packet even if a second-class NW server is removed from or added to a service chain.

Exemplary Configuration of Management Server

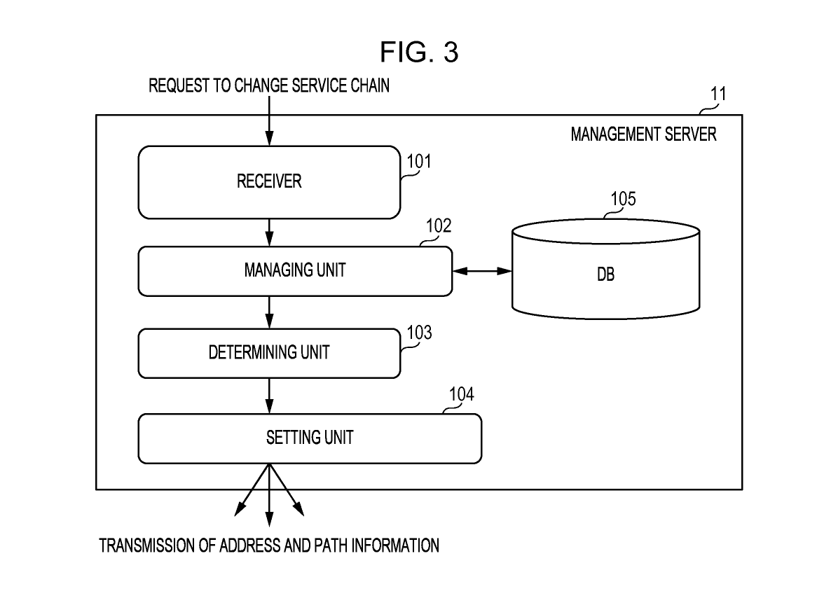

FIG. 3 is a diagram illustrating an exemplary configuration of the management server 11. The management server 11 assigns addresses to NW servers 16 and NW servers 17 and sets a path to relay devices 15 for relaying a packet and the NW servers 16 and 17.

Referring to FIG. 3, the management server 11 includes a receiver 101 configured to receive a request to change a service chain, a managing unit 102 configured to manage the service chain, a determining unit 103 configured to determine addresses and the paths, a setting unit 104 configured to set the addresses and the paths, and a database (DB) 105 configured to store information on the configuration of the service chain.

The receiver 101 receives a request to change the configuration of the service chain from a network administrator or a user who uses the network. The request to change the configuration of the service chain is a request to add an NW server to the transfer path (service chain) for a packet to be transferred through one or multiple NW servers or is a request to remove an NW server from the transfer path. The request to add a NW server identifies a position at which the NW server is added to an established service chain. The request to remove an NW server specifies the NW server to be removed from the established service chain. The receiver 101 transfers, to the managing unit 102, the received request to change the service chain.

The managing unit 102 manages the established service chain. The managing unit 102 accesses the DB 105 and searches for a positional relationship between the NW server requested to be added or removed and the established service chain. The managing unit 102 also searches the service chain for a second-class NW server configured to change a destination address, set by the transmitting terminal (terminal 12), of a packet. Then, the managing unit 102 stores, as an access address, an address assigned to the found NW server.

The determining unit 103 changes an address to another address on the basis of the positional relationship between the NW server to be added or removed and the established service chain, which is found by the managing unit 102. The determining unit 103 also assigns a new address to the added NW server. Further, the determining unit 103 changes path information set in existing NW servers and relay devices located on the path on the basis of the change in the address or the assignment of the new address.

The setting unit 104 notifies the new address determined by the determining unit 103 or the changed address and settings of the path to the NW servers and the relay devices located on the path and thereby sets the address.

Information on the established service chain is registered in the DB 105. The DB 105 stores, as the information on the service chain, a list of NW servers included in the service chain, addresses assigned to the respective NW servers, and the path information registered in the respective NW servers and the respective relay devices located on the path.

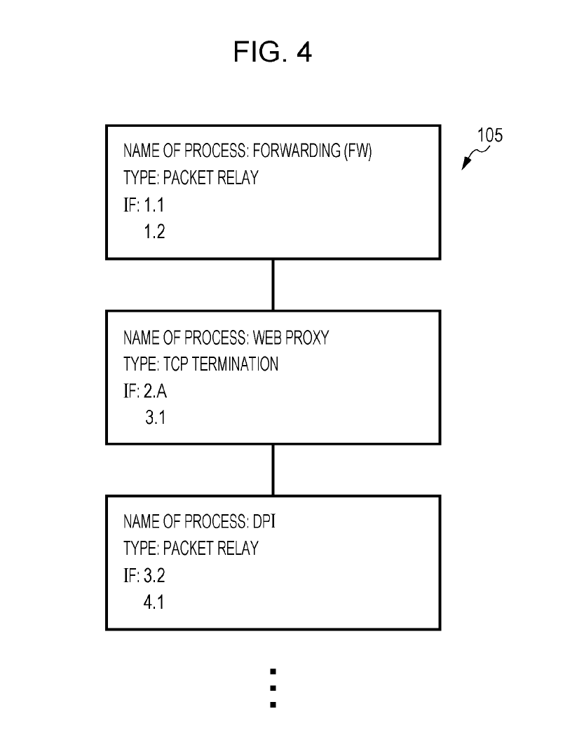

FIG. 4 illustrates an exemplary data structure of the DB 105 storing information on the configuration of the service chain. As illustrated in FIG. 4, the DB 105 is a collection of tables for NW servers forming the service chain, while the tables are arranged in order of the reception of a packet by the NW servers forming the service chain. The DB 105 may include collections of tables for respective service chains.

The tables each include a name of a process to be executed by an NW server, information on a type of the process, and interface information. The name of a process indicates a name of the process to be executed by an NW server. The name of the process is “forwarding (FW)”, “DPI”, “firewall”, “web proxy”, “web cache”, “NAT”, or the like, for example. The “forwarding (FW)”, the “DPI”, the “firewall”, and the like are executed by first-class NW servers, while the “web proxy”, the “web cache”, the “NAT”, and the like are executed by second-class NW servers.

The information on the type indicates a type of a process to be executed by an NW server. Whether or not the NW server changes a destination address of a packet is identified on the basis of the type of the process. The type is “packet relay” corresponding to the DPI and the firewall, “TCP termination” corresponding to the web proxy and the like, “address conversion” corresponding to the NAT, or the like.

The interface information is information on interfaces included in an NW server. The interface information includes interface information on the transmitting terminal side and interface information on the receiving terminal side. The interface information on the transmitting terminal side is an address assigned to an interface located on the transmitting terminal side in the NW server. The interface information on the receiving terminal side is an address assigned to an interface located on the receiving terminal side in the NW server. In FIG. 4, for example, “IF: 2.A” that corresponds to the process name “web proxy” indicates an address assigned to an interface that is included in an NW server having a web proxy function and is located on the transmitting terminal side, while “3.1” indicates an address assigned to an interface that is included in the NW server having the web proxy function and is located on the receiving terminal side.

The data structure of the DB 105 illustrated in FIG. 4, however, is an example. It is sufficient if the DB 105 has a structure that specifies at least the names (information identifying the processes) of the processes to be executed by the NW servers forming the service chain, the transfer types, the positions of the NW servers in the service chain, and the addresses of the NW servers. The tables illustrated in FIG. 4 include the information on the types. The DB 105, however, may include tables of the names of the processes and corresponding types and be configured to ensure that when a name of a process is designated, information on a type corresponding to the designated name is identified from the table, for example.

If the DB 105 has the aforementioned data structure, a request to add an NW server and a request to remove an NW server each include at least information identifying a service chain, a name of a process, and information indicating a position at which the NW server is to be added or a position from which the NW is to be removed.

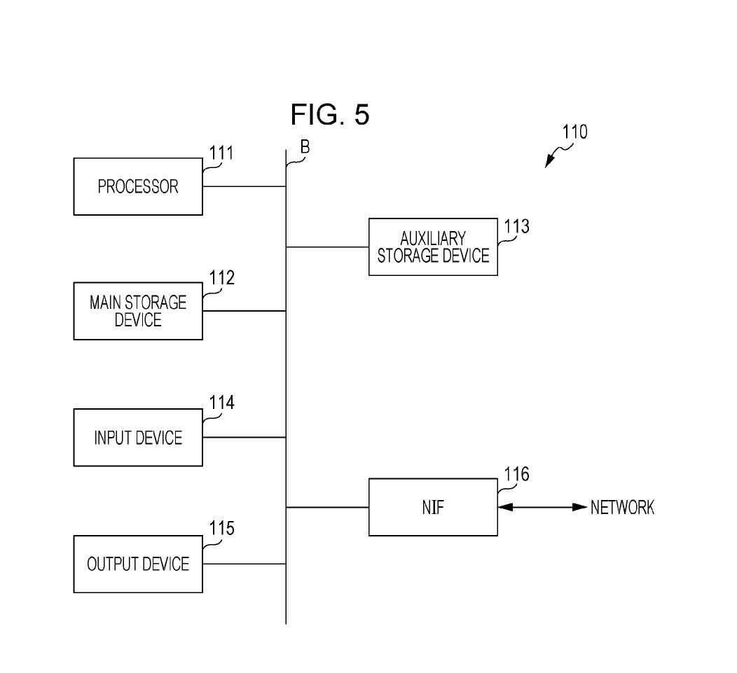

FIG. 5 illustrates an exemplary hardware configuration of an information processing device (computer) 110 that operates as the management server 11. The information processing device 110 is a dedicated computer as a server machine. The information processing device 110 may be a general-purpose computer such as a personal computer (PC) or a workstation (WS).

Referring to FIG. 5, the information processing device 110 includes a processor 111, a main storage device 112, an auxiliary storage device 113, an input device 114, an output device 115, and a network interface (NIF) 116 that are connected to each other through a bus B.

The input device 114 is a keyboard, a pointing device such as a mouse, or the like. Data input from the input device 114 is supplied to the processor 111. The output device 115 outputs a result of a process executed by the processor 111. The output device 115 includes an audio output device such as a speaker, a display, or a printer, for example.

The NIF 116 is an interface circuit configured to receive and output information from and to a network. The NIF 116 may be an interface connected to a wired network or may include an interface connected to a wireless network. The NIF 116 is at least one selected from among a network interface card (NIC), a wireless local area network (LAN) card, and the like, for example. Data and the like received by the NIF 116 are supplied to the processor 111. In addition, the NIF 116 outputs data supplied from the processor 111 to the network. The NIF 116 is connected to the relay devices 15, the NW servers 16, and the NW servers 17 through the network.

The auxiliary storage device 113 stores various programs and data to be used by the processor in the execution of the programs. The auxiliary storage device 113 is at least one nonvolatile storage medium (memory) selected from among an erasable programmable read-only memory (EPROM), a hard disk drive (HDD), a solid state drive (SSD), a flash memory, and the like. The auxiliary storage device 113 stores therein, as the various programs, an operating system (OS), a data storage destination determination program, and other various application programs, for example. The auxiliary storage device 113 may include a portable recording medium such as a universal serial bus (USB) memory and a disc recording medium such as a compact disc (CD) or a digital versatile disc (DVD).

The main storage device 112 provides, to the processor 111, a work region and a storage region into which the programs stored in the auxiliary storage device 113 are loaded. The main storage device 112 is also used as a buffer. The main storage device 112 is a semiconductor memory such as a random access memory (RAM), for example. The main storage device 112 may include a read-only memory (ROM).

The processor 111 is a central processing unit (CPU) or a micro processing unit (MPU), for example. The processor 111 may include a digital signal processor (DSP). The processor 111 loads the OS and the application programs stored in the auxiliary storage device 113 into the main storage device 112 and executes the OS and the application programs to perform various processes. The number of processors 111 included in the information processing device 110 is not limited to one, and the information processing device 110 may include a plurality of processors 111.

The processor 111 is an example of “control device” and “controller”. Each of the main storage device 112 and the auxiliary storage device 113 is an example of “storage device”, “memory”, and “computer-readable recording medium”.

The receiver 101, the managing unit 102, the determining unit 103, and the setting unit 104 illustrated in FIG. 3 are functions of the processor 111 that are achieved by causing the processor 111 to execute a program. The DB 105 is stored in at least one of the main storage device 112 and the auxiliary storage device 113.

The functions that are achieved by causing the processor 111 to execute the program may be achieved by an integrated circuit or a wired logic (hardware logic) using a programmable logic device (PLD). The integrated circuit includes at least one of an integrated circuit (IC), a large-scale integrated (LSI) circuit, and an application specific integrated circuit (ASIC). The PLD includes at least a field programmable gate array (FPGA).

### OPERATION EXAMPLES

Next, examples of operations of the management server 11 are described.

### First Operation Example

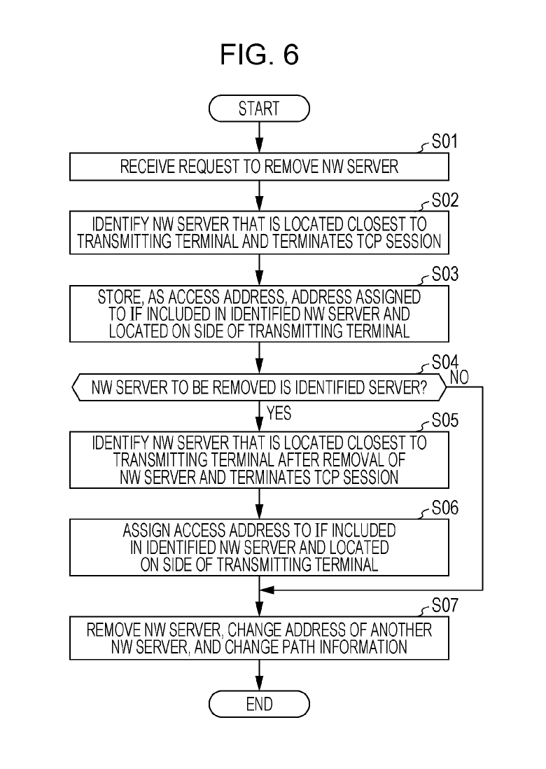

FIG. 6 is a flowchart illustrating, as a first operation example, an example (example of a process to be executed by the processor 111 of the information processing device 110) of operations of the management server 11 when the management server 11 receives a request to remove an NW server from a service chain.

The management server 11 (processor 111) receives a request to remove an NW server (in S01). The remove request may be input from the input device 114 or received by the NIF 116 from another device.

The management server 11 (processor 111) identifies an NW server that is located closest to the transmitting terminal (terminal 12) and that terminates a TCP session in a service chain (path of a packet), that is, executes a process of changing a destination address (address of a destination device) set by the terminal 12 in the packet received from the terminal 12 (in S02). Subsequently, the management server 11 (processor 111) stores, as an access address, an address assigned to an interface that is included in the NW server identified in S02 and is located on the transmitting terminal side (in S03). The access address is stored in at least one of the main storage device 112 and the auxiliary storage device 113.

In the example illustrated in FIG. 4, if the NW server to be removed is a web proxy, the management server 11 (processor 111) identifies a table of the web proxy and stores, as the access address, the address “2.A” of an interface located on the transmitting terminal side.

The management server 11 (processor 111) determines whether or not the NW server requested to be removed is the NW server identified in S02. If the NW server requested to be removed is the NW server identified in S02 (Yes in S04), the process proceeds to S05. If the NW server requested to be removed is not the NW server identified in S02 (No in S04), the process proceeds to S07.

The management server 11 (processor 111) identifies an NW server that is located closest to the transmitting terminal (terminal 12) after the removal of the target NW server (or receives the packet including the destination address set by the terminal 12) and that terminates the TCP session in the service chain (path of a packet) (in S05). Subsequently, the management server 11 (processor 111) assigns the access address stored in S03 to an interface that is included in the NW server identified in S05 and is located on the transmitting terminal side (in S06).

The management server 11 (processor 111) removes the target NW server and may change an address of another NW server and change path information as needed. For example, the management server 11 (processor 111) changes an address of an NW server located adjacent to the removed NW server. In addition, the management server 11 (processor 111) notifies corresponding NW servers and relay devices of a change in the path due to the assignment of the access address to the other NW server in S06 and the change in the address of the aforementioned adjacent NW server.

### First Specific Example of First Operation Example

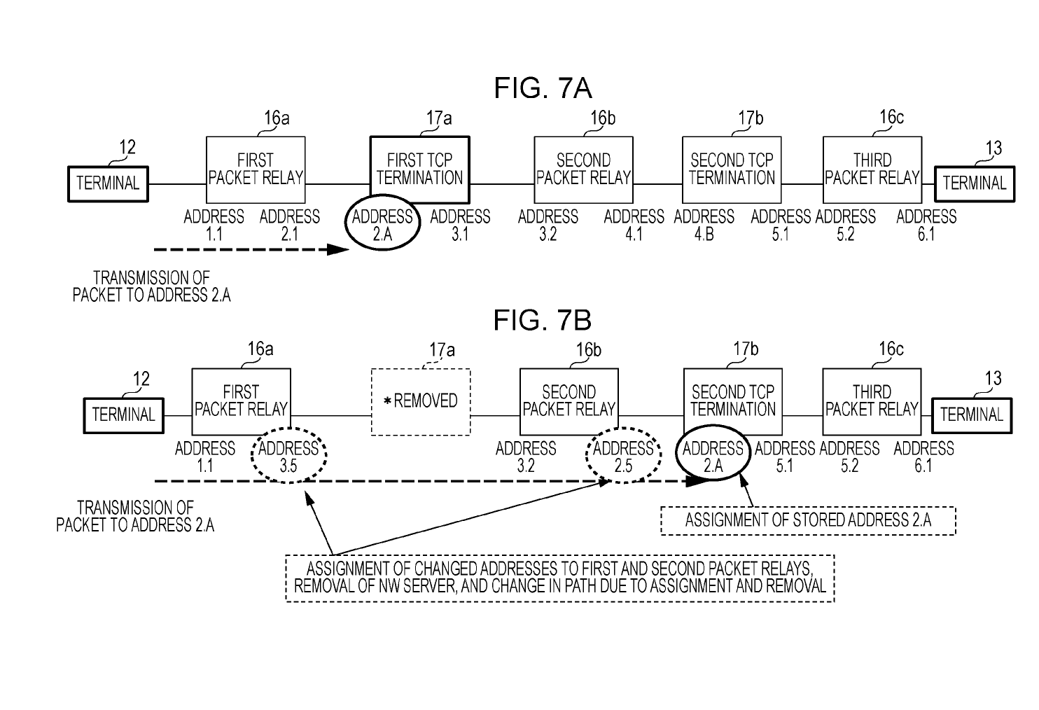

FIGS. 7A and 7B illustrate a first specific example of the operations (first operation example illustrated in FIG. 6) of the management server 11. A service chain illustrated in FIG. 7A is the same as the service chain illustrated in FIG. 15.

The first specific example of the first operation example assumes that the NW server 17a (first TCP termination) is removed from the service chain illustrated in FIG. 7A. In this case, the management server 11 receives a request to remove the NW server 17a (first TCP termination) (in S01 illustrated in FIG. 6).

Next, the management server 11 identifies the NW server 17a as an NW server that is located closest to the transmitting terminal and that terminates a TCP session, that is, changes a destination address set by the terminal 12 and included in a packet (in S02 illustrated in FIG. 6). Subsequently, the management server 11 stores, as an access address, the address “2.A” assigned to an interface included in the NW server 17a and located on the transmitting terminal side (in S03 illustrated in FIG. 6).

Next, the management server 11 determines whether or not the NW server to be removed is the identified NW server 17a (in S04 illustrated in FIG. 6). In the example illustrated in FIG. 7A, the management server 11 determines that the NW server to be removed is the NW server 17a. Next, the management server 11 identifies the NW server 17b (second TCP termination) as an NW server that is located closest to the transmitting terminal after the removal of the NW server 17a and that terminates a TCP session (in S05 illustrated in FIG. 6).

The management server 11 assigns the access address “2.A” to the NW server 17b (in S06 illustrated in FIG. 6), as illustrated in FIG. 7B. Next, the management server 11 removes the NW server 17a (first TCP termination) (in S07 illustrated in FIG. 6). By this operation, the NW server 16a (first packet relay) and the NW server 16b (second packet relay) are connected to each other. Thus, the management server 11 assigns, to the NW server 16a (first packet relay), an address “3.5” that is an unused address within the same subnet as the NW server 16b (second packet relay) located on the downstream side, for example. Similarly, since the address “2.A” is newly assigned to the NW server 17b (second TCP termination), the management server 11 assigns, to the NW server 16b (second packet relay) connected to the NW server 17b (second TCP termination), an address “2.5” that is an unused address within the same subnet as the NW server 17b (second TCP termination) located on the downstream side, for example. Then, the management server 11 provides a notification to add information on a path directed to the destination address “2.A” to routing tables of the NW servers 16a and 16b.

The NW server 17a described in the first specific example of the first operation example is an example of “first network server”, and the NW server 17b is an example of “second network server”. As described above, in the first specific example of the first operation example, the address of the NW server 17a that is configured to execute the process of changing the destination address set by the terminal 12 is stored as the access address, and the access address is assigned to the NW server 17b that is to be configured to execute the process of changing the destination address set by the terminal 12 instead of the NW server 17a. This operation avoids a change in the destination address set by the terminal 12.

### Second Specific Example of First Operation Example

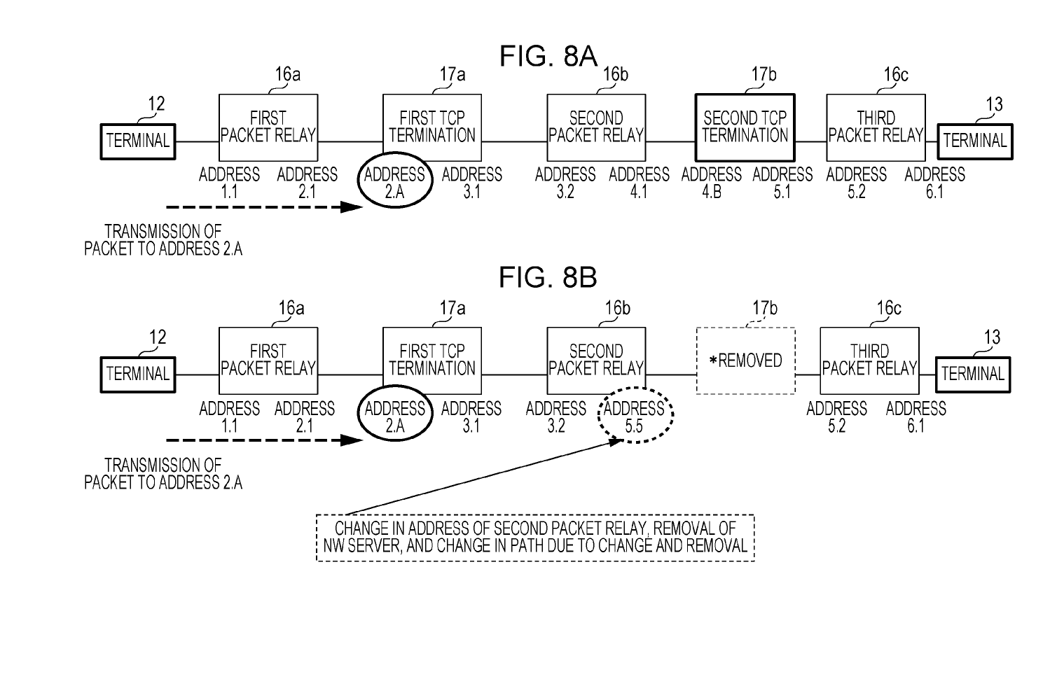

FIGS. 8A and 8B illustrate a second specific example of the operations (first operation example illustrated in FIG. 6) of the management server 11. A service chain illustrated in FIG. 8A is the same as the service chain illustrated in FIG. 7A. The second specific example of the first operation example assumes that the NW server 17b (second TCP termination) is removed from the service chain illustrated in FIG. 8A.

In this case, the management server 11 receives a request to remove the NW server 17b (second TCP termination) (in S01 illustrated in FIG. 6). Next, the management server 11 identifies the NW server 17a (in S02 illustrated in FIG. 6) and stores, as an access address, the address “2.A” assigned to the NW server 17a (in S03 illustrated in FIG. 6) in the same manner as the first specific example of the first operation example.

Next, the management server 11 determines whether or not the NW server to be removed is the identified NW server 17a. In the example illustrated in FIG. 8A, the NW server to be removed is the NW server 17b, and the management server 11 determines that the NW server to be removed is not the identified NW server 17a. In this case, S05 and S06 illustrated in FIG. 6 are not executed.

The management server 11 removes the NW server 17b (second TCP termination), as illustrated in FIG. 8B. In this case, the NW server 16b (second packet relay) and the NW server 16c (third packet relay) are connected to each other. Thus, the management server 11 assigns, to the NW server 16b (second packet relay), an address “5.5” that is an unused address within the same subnet as the NW server 16c (third packet relay) located on the downstream side, for example. Then, the management server 11 adds path information to the NW server 16b (second packet relay). For example, if a path directed to the destination address “Z” (address of the terminal 13) is set in the NW server 16c (third packet relay), the management server 11 sets the address “Z” in the routing table of the NW server 16b (second packet relay).

As described above, in the second specific example of the first operation example, a change in a destination address set by the terminal 12 may be avoided by changing address assignment and a path on the network side by the management server 11.

### Second Operation Example

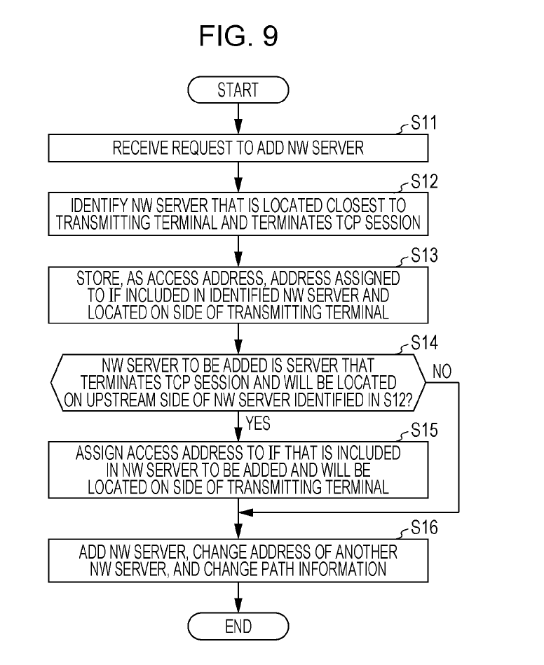

FIG. 9 is a flowchart illustrating, as a second operation example, an example (example of a process to be executed by the processor 111 of the information processing device 110) of operations of the management server 11 when the management server 11 receives a request to add an NW server to a service chain.

The management server 11 (processor 111) receives a request to add an NW server (in S11). The add request may be input from the input device 114 or received by the NIF 116 from another device.

The management server 11 (processor 111) identifies an NW server that is located closest to the transmitting terminal (terminal 12) and that terminates a TCP session in a service chain (path of a packet), that is, executes a process of changing a destination address (address of a destination device) set by the terminal 12 in the packet received from the terminal 12 (in S12). Subsequently, the management server 11 (processor 111) stores, as an access address, an address assigned to an interface that is included in the NW server identified in S12 and is located on the transmitting terminal side (in S13). The access address is stored in at least one of the main storage device 112 and the auxiliary storage device 113. S12 and S13 are the same as S02 and S03 illustrated in FIG. 6, respectively.

The management server 11 (processor 111) determines whether or not the NW server to be added will terminate a TCP session and be located on the upstream side of the NW server identified in S12, that is, on the transmitting terminal side (in S14). If the requirements for the determination made in S14 are satisfied (Yes in S14), the process proceeds to S15. If the requirements for the determination made in S14 are not satisfied (No in S14), the process proceeds to S16.

The management server 11 (processor 111) assigns the access address stored in S13 to an interface that is included in the NW server to be added and will be located on the transmitting terminal side (in S15). After that, the process proceeds to S16.

The management server 11 (processor 111) adds the target NW server and may change an address of another NW server and change path information (in S16). For example, the management server 11 (processor 111) changes an address of an NW server located adjacent to the added NW server. In addition, the management server 11 (processor 111) notifies corresponding NW servers and relay devices of a change in the path due to the assignment of the access address to the target NW server in S15 and the change in the address of the adjacent NW server.

### First Specific Example of Second Operation Example

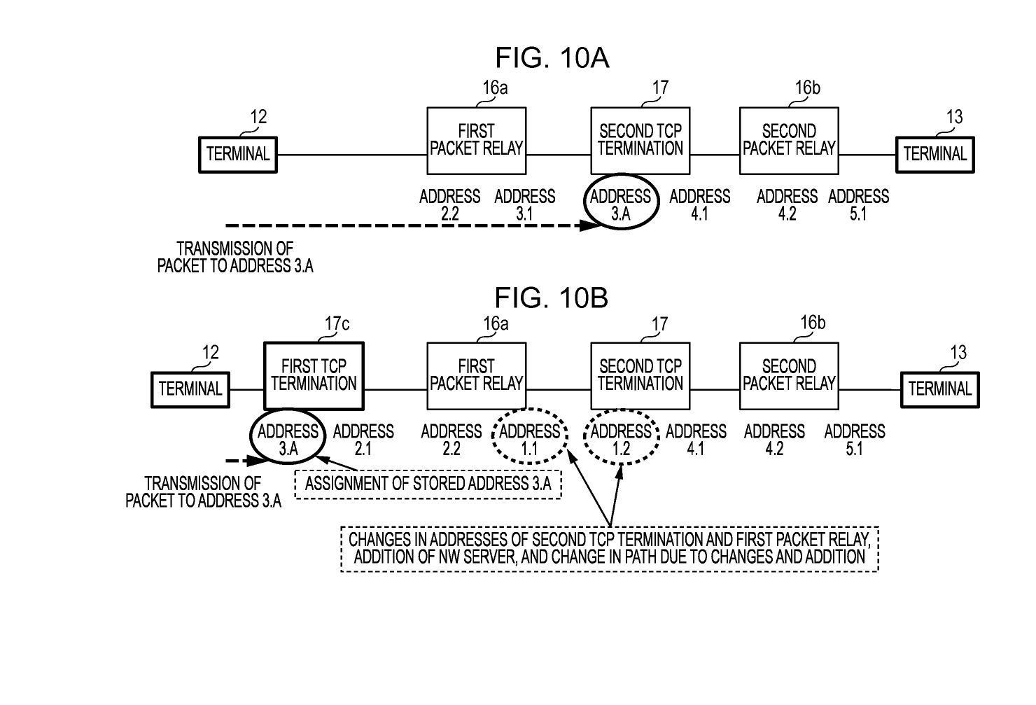

FIGS. 10A and 10B illustrate a first specific example of the operations (second operation example illustrated in FIG. 9) of the management server 11. A service chain illustrated in FIG. 10A is the same as the service chain illustrated in FIGS. 1 and 2. As illustrated in FIG. 10A, the service chain includes two NW servers, that is, the NW server 16a (first packet relay) and the NW server 16b (second packet relay), as NW servers (first-class NW servers) that do not change a destination address of a packet to be transferred. The service chain also includes the NW server 17 (second TCP termination) that terminates a TCP session as an NW server 17 (second-class NW server) that changes the destination address of the packet to be transferred. A packet transmitted by the terminal 12 (transmitting terminal) passes through the NW servers in order of the NW server 16a, the NW server 17, and the NW server 16b.

As illustrated in FIG. 10B, the first specific example of the second operation example assumes that an NW server 17c (first TCP termination) is added to the service chain illustrated in FIG. 10A. In this case, the management server 11 receives a request to add the NW server 17c (first TCP termination) (in S11 illustrated in FIG. 9).

Next, the management server 11 identifies the NW server 17 as an NW server that is located closest to the transmitting terminal and that terminates a TCP session, that is, changes the destination address set by the terminal 12 in the packet (in S12 illustrated in FIG. 9). Subsequently, the management server 11 stores, as an access address, an address “3.A” assigned to an interface included in the NW server 17 and located on the transmitting terminal side (in S13 illustrated in FIG. 9).

Next, the management server 11 determines whether or not the NW server 17c to be added will terminate a TCP session and be located on the transmitting terminal side with respect to the NW server 17 identified in S12 (in S14 illustrated in FIG. 9). In the example illustrated in FIG. 10B, the NW server 17c will be located on the upstream side of the NW server 17.

Thus, the management server 11 assigns the access address “3.A” stored in S13 to an interface that is included in the NW server 17c (first TCP termination) to be added and will be located on the transmitting terminal side (in S15 illustrated in FIG. 9). Subsequently, the management server 11 adds the NW server 17c (first TCP termination).

At this time, the management server 11 assigns, to an interface that is included in the NW server 17c and is not located on the transmitting terminal side, an address “2.1” that is an unused address within the same subnet as the NW server 16a (first packet relay) located on the downstream side, which includes an address “2.2” of the NW server 16a, for example. In addition, the management server 11 assigns a new address “1.2” to the NW server 17 (second TCP termination) to which the access address has been assigned, for example. Furthermore, the management server 11 assigns, to the NW server 16a (first packet relay), an address “1.1” that is an unused address within the same subnet as the NW server 17 (second TCP termination) located on the downstream side, which includes the newly assigned address “1.2” of the NW server 17, for example. Then, the management server 11 adds information on a path directed to the destination address “1.2” to the NW server 16a (first packet relay).

The NW server 17 described in the first specific example of the second operation example is an example of “first network server”, and the NW server 17c is an example of “second network server”. In the aforementioned first specific example of the second operation example, the management server 11 assigns the access address to the NW server 17c added and located on the upstream side of the NW server 17. Thus, a change in a destination address set by the terminal 12 may be avoided.

### Second Specific Example of Second Operation Example

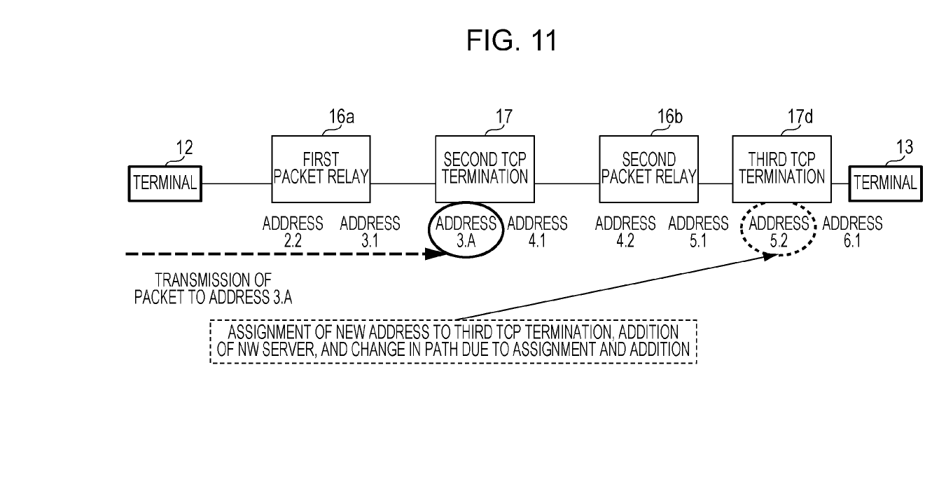

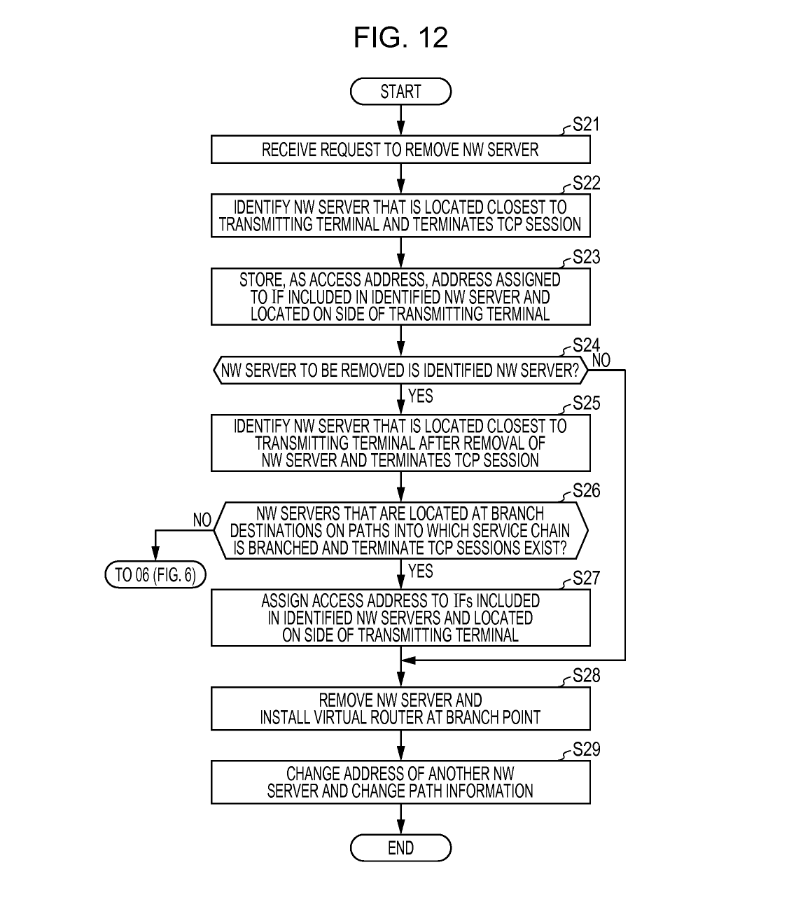

FIG. 11 illustrates a second specific example of the operations (second operation example illustrated in FIG. 9) of the management server 11. As illustrated in FIG. 11, the second specific example of the second operation example assumes that an NW server 17d (third TCP termination) is added to the service chain illustrated in FIG. 10A.

In this case, the management server 11 receives a request to add the NW server 17d (third TCP termination) (in S11 illustrated in FIG. 9). Next, the management server 11 identifies the NW server 17 as an NW server that is located closest to the transmitting terminal and that terminates a TCP session, that is, changes the destination address set by the terminal 12 in the packet (in S12 illustrated in FIG. 9). Subsequently, the management server 11 stores, as an access address, the address “3.A” assigned to the interface included in the NW server 17 and located on the transmitting terminal side (in S13 illustrated in FIG. 9).

Next, the management server 11 determines whether or not the NW server 17d to be added will terminate a TCP session and be located on the transmitting terminal side with respect to the NW server 17 identified in S12 (in S14 illustrated in FIG. 9). In the example illustrated in FIG. 11, the NW server 17d will be located on the downstream side of the NW server 17. Thus, the management server 11 does not assign the access address to the NW server 17d (third TCP termination) to be added.

The management server 11 adds the NW server 17d (third TCP termination). In addition, the management server 11 assigns, to an interface included in the NW server 17d (third TCP termination) and located on the transmitting terminal side, an address “5.2” that is an unused address within the same subnet as the NW server 16b (second packet relay) located on the upstream side, which includes an address “5.1” of the NW server 16b, for example. Then, the management server 11 adds information on a path directed to the destination address “5.2” to the NW server 16b (second packet relay).

In the aforementioned second specific example of the second operation example, the management server 11 changes an assigned address and a path due to the addition of the NW server 17d and may avoid a change in the destination address set by the terminal 12.

### Third Operation Example

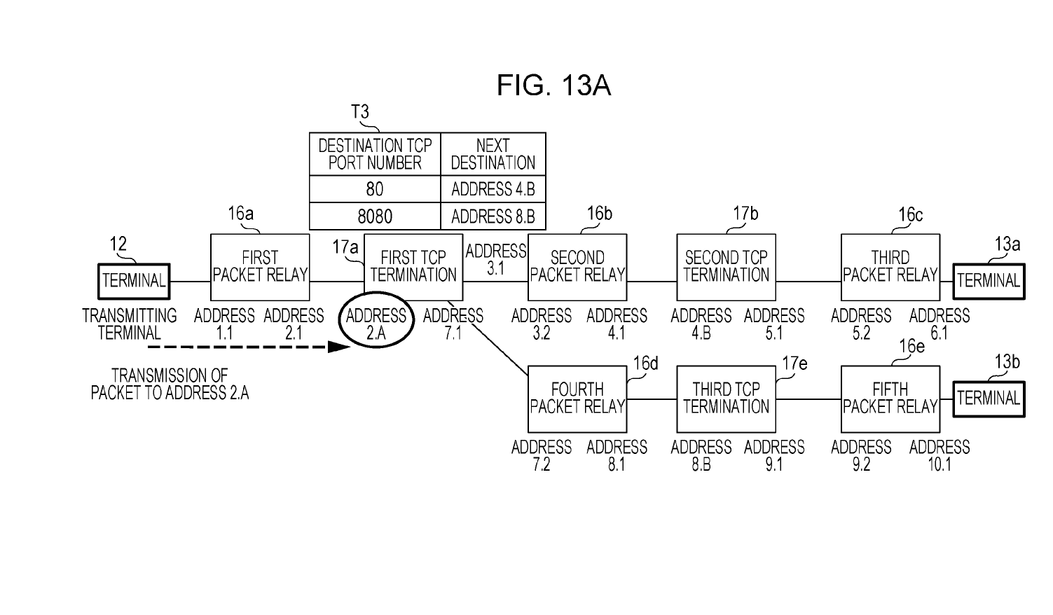

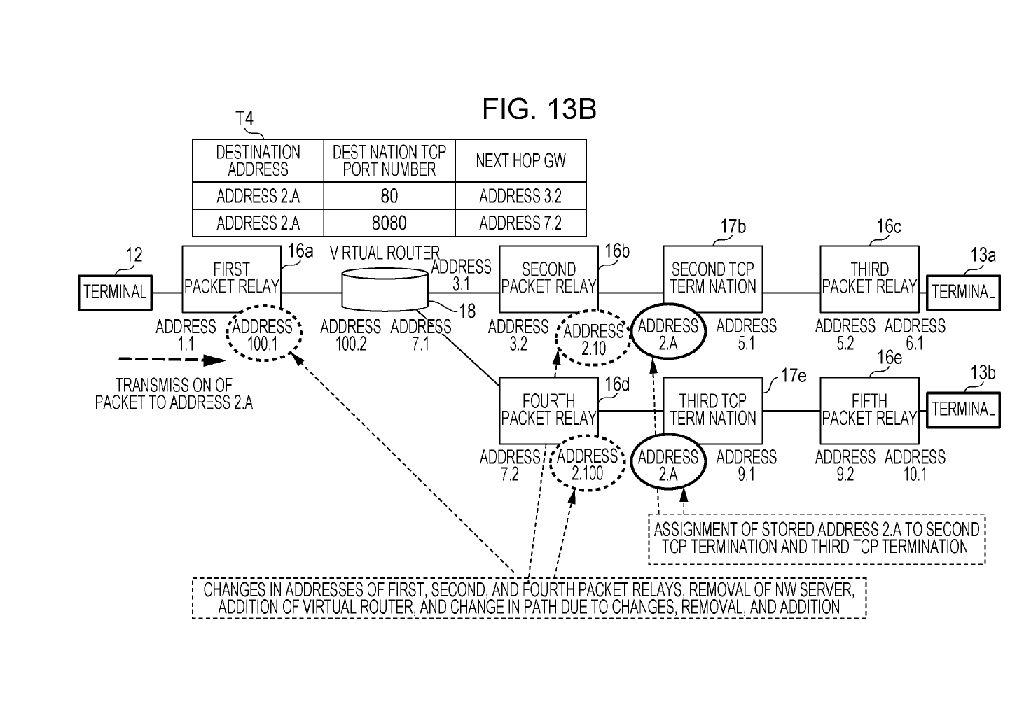

FIG. 12 is a flowchart illustrating, as a third operation example, an example (example of a process to be executed by the processor 111 of the information processing device 110) of operations of the management server 11 when the management server 11 receives a request to remove an NW server 17 (second-class NW server) from a service chain including a branch. FIGS. 13A and 13B are diagrams illustrating a specific example of the third operation example of the management server 11.

First, a service chain according to the third operation example is described with reference to FIG. 13A. The service chain illustrated in FIG. 13A includes a service chain composed of the NW servers 16a, 16b, and 16c and the NW servers 17a and 17b, like the service chain illustrated in FIG. 7A. The service chain according to the third operation example is branched at the NW server 17a and to include a service chain extending through an NW server 16d (fourth packet relay), an NW server 17e (third TCP termination), and an NW server 16e (fifth packet relay). The third operation example is an example of the operations in the case where the service chain has multiple (two) paths (service chains) after a branch.

The flowchart illustrated in FIG. 12 illustrates operations (process to be executed by the processor 111 of the information processing device 110) of the management server 11 when the management server 11 receives a request to remove a second-class NW server from the service chain including a branch as illustrated in FIG. 13A.

S21 to S25 illustrated in FIG. 12 are the same as S1 to S5 illustrated in FIG. 6, and a description thereof is omitted. The management server 11 (processor 111) determines whether or not NW servers, which will receive, instead of the NW server to be removed, a packet including a destination address set by the terminal 12, exist on the respective paths after the branch (in S26).

If no NW server exists on the paths after the branch (or an NW server exists on only one of the paths after the branch (No in S26), the process proceeds to S06 illustrated in FIG. 6. On the other hand, if the NW servers exist on the respective paths after the branch (Yes in S26), the process proceeds to S27.

The management server 11 (processor 111) assigns the access address to interfaces that are included in the NW servers on the respective paths identified in S26 and are located on the transmitting terminal side (in S27).

The management server 11 (processor 111) removes the target NW server and installs a virtual router at a branch point (in S28). Specifically, the management server 11 (processor 111) adds the virtual router (or a real router) at the branch point. Subsequently, the management server 11 (processor 111) sets, in the virtual router, a policy-based routing entry that causes a similar operation as a path switching operation executed by the removed NW server.

For example, if the service chain is branched at the NW server to be removed, the management server 11 (processor 111) replaces the NW server to be removed with the virtual router and adds the policy-based routing entry to the virtual router. On the other hand, if the service chain is branched at another NW server, the management server 11 (processor 111) adds the policy-based routing entry to the other NW server to ensure that the other NW server executes the policy-based routing.

The management server 11 (processor 111) may change an address of another NW server and change path information as needed (in S29). For example, the management server 11 (processor 111) changes an address of an NW server located adjacent to the removed NW server. In addition, the management server 11 (processor 111) may change a path due to the assignment of the access address to the other NW servers in S27 and the change in the address of the aforementioned adjacent NW server.

Next, a specific example of the third operation example is described with reference to FIGS. 13A and 13B. The specific example of the third operation example assumes that the NW server 17a (first TCP termination) at a branch point is removed from a service chain illustrated in FIG. 13A.

In this case, the management server 11 receives a request to remove the NW server 17a (first TCP termination) (in S21 illustrated in FIG. 12). Next, the management server 11 identifies the NW server 17a (first TCP termination) as an NW server that is located closest to the transmitting terminal and that terminates a TCP session, that is, changes a destination address set by the terminal 12 and included in a packet (in S22 illustrated in FIG. 12). Subsequently, the management server 11 stores, as an access address in at least one of the main storage device 112 and the auxiliary storage device 113, the address “2.A” assigned to an interface included in the NW server 17a and located on the transmitting terminal side (in S23 illustrated in FIG. 12).

Next, the management server 11 determines whether or not the NW server to be removed is the identified NW server 17a (in S24 illustrated in FIG. 12). In the example illustrated in FIG. 13A, since the NW server to be removed is the identified NW server 17a, the process proceeds to S25.

As illustrated in FIG. 13B, the management server 11 identifies the NW server 17b (second TCP termination) on one of the two paths after the branch as an NW server that is located closest to the terminal 12 after the removal of the NW server 17a and that terminates a TCP session (in S25 illustrated in FIG. 12). In addition, the management server 11 identifies the NW server 17e on the other path after the branch (in S26 illustrated in FIG. 12). In the example illustrated in FIG. 13B, two NW servers (NW servers that receive the packet including the destination address set by the terminal 12 instead of the NW server to be removed) exist that are located closest to the terminal 12 after the removal of the NW server 17a and that terminate a TCP session. Thus, the management server 11 assigns the access address “2.A” to interfaces included in the NW servers 17b and 17e and located on the transmitting terminal side (in S27 illustrated in FIG. 12).

The management server 11 removes the NW server 17a (first TCP termination). The service chain is branched at the NW server 17a. Thus, the management server 11 replaces the NW server 17a with a virtual router 18 and adds an entry to a policy-based routing table T4 of the virtual router 18 on the basis of a policy-based routing table T3 of the removed NW server 17a (in S28 illustrated in FIG. 12).

For example, it is assumed that the policy-based routing table T3 of the NW server 17a (first TCP termination) has an entry indicating that a packet that has a TCP port number “80” is transmitted to the NW server 17b (second TCP termination) and an entry indicating that a packet that has a TCP port number “8080” is transmitted to the NW server 17e (third TCP termination) as illustrated in FIG. 13A. In this case, entries of the policy-based routing table T4 are set as follows. As illustrated in FIG. 13B, the entries each include a destination identifier (destination address), a destination TCP port number, and a next hop gateway address (next hop GW, also referred to as “next hop address”) associated with the destination address and the destination TCP port number.

In the data structure of the policy-based routing table T4, the address “2.A”, the destination TCP port number “80”, and a next hop address “3.2” are registered as an entry for the NW server 17b. In addition, the address “2.A”, the destination TCP port number “8080”, and a next hop address “7.2” are registered as an entry for the NW server 17e.

After that, the management server 11 assigns, to the virtual router 18, an address to be used to connect the virtual router 18 to the NW server 16a (first packet relay), the NW server 16b (second packet relay), and the NW server 16d (fourth packet relay) and may change addresses of the NW servers 16a, 16b, and 16d.

The management server 11 has assigned the access address to the NW server 17b (second TCP termination) and the NW server 17e (third TCP termination). Thus, the management server 11 assigns, to the NW server 16b (second packet relay) connected to the NW server 17b (second TCP termination), an address “2.10” that is an unused address within the same subnet as the NW server 17b, for example. In addition, the management server 11 assigns, to the NW server 16d (fourth packet relay) connected to the NW server 17e (third TCP termination), an address “2.100” that is an unused address within the same subnet as the NW server 17e, for example.

The NW server 17a described in the specific example of the third operation example is an example of “first network server”. The NW server 17b and the NW server 17e are examples of “plurality of second network servers”. The virtual router 18 is an example of “relay device”.

In the third operation example, the access address “2.A” is assigned to multiple network servers (NW servers 17b and 17e) that are configured to receive the packet including the destination address set by the terminal 12 and change the destination address instead of the removed NW server 17a. Thus, a change in the destination address set by the terminal 12 may be avoided.

Building of NW Servers and Relay Devices Using Network Functions Virtualization (NFV)

Although dedicated server devices and dedicated relay devices may be applied to the NW servers and the relay devices described in the embodiment, the NW servers and the relay devices described in the embodiment may be built using the NFV technique described below. Specifically, the “network servers (NW servers)” each include an NW function installed using the NFV technique.

In recent years, the technique that is referred to as the network functions virtualization (NFV) has attracted attention. NFV is a technique for achieving a network function which is conventionally achieved with a dedicated communication device by providing an application program and executing the application program by a general-purpose server. The use of NFV enables the inexpensive general-purpose server to be used, enables a network function to be quickly added and changed.

The Network Functions Virtualization Industry Specification Group (NFVISG) of the European Telecommunications Standards Institute (ETSI) has considered a use case in which communication to be executed through NW servers is achieved by NFV. In the use case, a service chain in which network functions (NW functions or functions included in the NW servers) having different functionalities to be executed on the general-purpose servers are sequentially connected to each other is configured and a packet is transferred through the NW servers.

In the use case, a service chain is configured in which different functions (network functions or NW functions) of NW servers, which are executed on general-purpose servers, are sequentially connected to each other, and a packet is transferred through the NW servers.

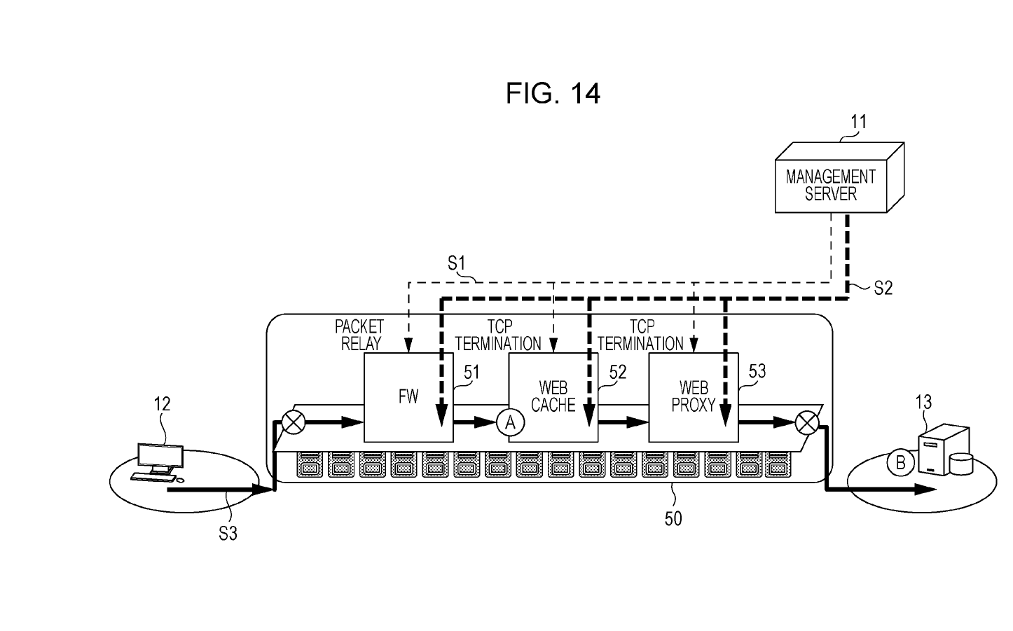

FIG. 14 illustrates an exemplary service chain built using NFV. In the example illustrated in FIG. 14, the management server 11 installs NW functions (virtual machines that are each executed as an NW server or a relay device) to a general-purpose server 50 on a network in accordance with a request from a user (in S1). Specifically, application programs that cause the general-purpose server 50 to operate as desired NW servers or desired relay devices are installed in the general-purpose server 50. The management server 11 provides, to the general-purpose server 50, a command to activate the NW functions. The general-purpose server 50 starts executing the application programs and activates the NW functions. In the example illustrated in FIG. 14, an NW function 51 that serves as a packet relay function, an NW function 52 that serves as a web cache function, and an NW function 53 that serves as a web proxy function, are equipped on the general-purpose server 50.

Subsequently, the management server 11 assigns addresses to the equipped NW functions 51, 52, and 53, sets a path in a virtual network within a hypervisor which is middleware executed by the general-purpose server 50 to run a virtual machine and a real network that connects the servers to each other (in S2).

The terminal 12 that is a source of a packet changes a destination address of the packet to be transmitted, on the basis of whether or not an NW function (NW function for terminating a TCP session or changing an address) to be operated as a second-class NW server exists in the service chain. If the NW function to be operated as a second-class NW server does not exist in the service chain, the terminal 12 transmits a packet (having a destination address “B” set therein) toward the terminal 13 (having the address “B”). In the example illustrated in FIG. 14, a path is set, which includes the NW functions 52 and 53 to be operated as second-class NW servers and in which the NW function 52 receives a packet including the destination address set by the terminal 12. Thus, the terminal 12 transmits a packet toward the NW function 52 (having the address “A”), that is, transmits a packet having the destination address “A” set therein (in S3). Multiple general-purpose servers 50 that implement the NW functions may be prepared.

NFV allows NW servers (NW functions) to be easily added and removed. In the third operation example, the replacement of the NW server 17a with the virtual router 18 may be performed by terminating an application program for the NW server 17a and activate an application program for the virtual router 18 on the general-purpose server 50. In this manner, by building NW servers using NFV, change of an address and a path due to addition or removal of an NW server may be easily performed.

If an NW server that changes a destination address exists in a service chain, the transmitting terminal adds, to a packet, a specific destination address for causing the packet to be directed to an address of the NW server and transmits the packet. Thus, it is considered that the destination address of the packet to be transmitted is changed upon the addition or removal of an NW server to or from the service chain.

According to a method of controlling packet transfer according to the embodiment, when an NW server is added to or removed from a service chain, addresses of NW servers within the service chain are changed. Therefore, the transmitting terminal (terminal 12) may continuously transmit a packet having the same destination address without consideration of the addition or the removal. Thus, if a large number of terminals that transmit packets using a service chain exist, time and effort to change and set destination addresses in the terminals may be reduced and NW servers may be easily added and removed.

In addition, NW servers may be easily added and removed by applying the aforementioned NFV technique and activating and stopping functions achieved by executing the application programs for causing general-purpose servers to operate as NW servers. When NFV is applied, it is considered that a frequency at which an NW server is added or removed is high. Thus, an advantage of reducing time and effort to change and set a destination address in the terminal is large.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A method of controlling packet transfer, the method comprising:
detecting, by a computer, a key server located on a path through which a packet transmitted from a terminal is transferred, the key server being one of network servers located on the path, the key server satisfying a predetermined condition, each of the network servers being configured to receive the packet and change a destination address set in the packet;
detecting the key server located on a first path;
detecting the key server located on a second path upon the first path being modified to obtain the second path; and
assigning, if the key server located on the second path is different from the key server located on the first path, a first address to the key server located on the second path, the first address being assigned to the key server located on the first path.

2. The method according to claim 1, wherein
the first path is modified to obtain the second path by removing the key server located on the first path.

3. The method according to claim 1, wherein
the predetermined condition is that none of the network servers other than the key server exists between the terminal and the key server.

4. The method according to claim 1, wherein
If the computer detects more than one key server located on the second path, the computer assigns the first address to each of the more than one key server, and the computer notifies a relay device of a setting to transfer a packet received from the terminal to each of the more than one key server.

5. The method according to claim 1, wherein
the first path is modified to obtain the second path by adding the key server located on the second path.

6. The method according to claim 1, wherein
at least one of the key server located on the first path and the key server located on the second path is set by network functions virtualization.

7. A management server, comprising:
a processor configured to
detect a key server located on a path through which a packet transmitted from a terminal is transferred, the key server being one of network servers located on the path, the key server satisfying a predetermined condition, each of the network servers being configured to receive the packet and change a destination address set in the packet;
detect the key server located on a first path;
detect the key server located on a second path upon the first path being modified to obtain the second path; and
assign, if the key server located on the second path is different from the key server located on the first path, a first address to the key server located on the second path, the first address being assigned to the key server located on the first path.

8. The management server according to claim 7, wherein
the first path is modified to obtain the second path by removing the key server located on the first path.

9. The management server according to claim 7, wherein
the predetermined condition is that none of the network servers other than the key server exists between the terminal and the key server.

10. The management server according to claim 7, wherein
the processor is configured to
assign, upon detecting more than one key server located on the second path, the first address to each of the more than one key server; and
notify a relay device of a setting to transfer a packet received from the terminal to each of the more than one key server.

11. The management server according to claim 7, wherein
the first path is modified to obtain the second path by adding the key server located on the second path.

12. The management server according to claim 7, wherein
the processor is configured to
set at least one of the key server located on the first path and the key server located on the second path by network functions virtualization.

13. A computer-readable recording medium having stored therein a program that causes a computer to execute a process, the process comprising:
detecting a key server located on a path through which a packet transmitted from a terminal is transferred, the key server being one of network servers located on the path, the key server satisfying a predetermined condition, each of the network servers being configured to receive the packet and change a destination address set in the packet;
detecting the key server located on a first path;
detecting the key server located on a second path upon the first path being modified to obtain the second path; and
assigning, if the key server located on the second path is different from the key server located on the first path, a first address to the key server located on the second path, the first address being assigned to the key server located on the first path.

14. The computer-readable recording medium according to claim 13, wherein
the first path is modified to obtain the second path by removing the key server located on the first path.

15. The computer-readable recording medium according to claim 13, wherein
the predetermined condition is that none of the network servers other than the key server exists between the terminal and the key server.

16. The computer-readable recording medium according to claim 13, wherein
If the computer detects more than one key server located on the second path, the computer assigns the first address to each of the more than one key server, and the computer notifies a relay device of a setting to transfer a packet received from the terminal to each of the more than one key server.

17. The computer-readable recording medium according to claim 13, wherein
the first path is modified to obtain the second path by adding the key server located on the second path.

18. The computer-readable recording medium according to claim 13, wherein
at least one of the key server located on the first path and the key server located on the second path is set by network functions virtualization.
